(19) United States
(12) Patent Application Publication
(10) Pub. No.: US 2006/0247561 A1
(43) Pub. Date: Nov. 2, 2006

(54) Sound-controlled massaging apparatus

(76) Inventor: Yu-Mei Chiu, Tao-Yuan Hsien (TW)

Correspondence Address: LIN & ASSOCIATES INTELLECTUAL PROPERTY, P.O. BOX 2339, SARATOGA, CA, 95070-0339, US

(21) Appl. No.: 11/117,109

(22) Filed: Apr. 27, 2005

(51) Int. Cl. A61H 1/00

(52) U.S. Cl. 601/47; 601/46

(57) ABSTRACT

Sound-controlled massaging apparatus is disclosed, which delivers massaging actions corresponding to the audible music at an output thereof. The massage apparatus includes a power circuit, an audio signal processing circuit, a main control unit, a manual control unit, and a massage mechanism, wherein the main control unit includes a microcontroller chip U2 and a driving circuit, and the manual control unit includes a microcontroller chip U1, a control panel, a LCD display, and an input key control circuit. The massage mechanism includes a massage head that is able to produce rolling, drumming, and thumbing actions, and vibrators that produce vibration separately and jointly, and each vibrator is constructed with a sleeve, a motor, and an eccentric wheel. The sound-controlled massaging apparatus enables the user to monitor the massaging operation with variable intensity and frequency cycle controls.

### BACKGROUND OF THE INVENTION

1. Field of the Invention

The present invention relates to a sound-controlled massaging apparatus, and in particular to a health care equipment that is capable of delivering multiple massage functions, such as thumbing, rolling, drumming, and vibrating, corresponding to the audible music at an output thereof.

2. Related Art

The massage machines have been known for a long time, which are all intended to provide bodily relaxation, or just focused on certain parts of the body. Current designs of massaging apparatuses either use mechanical vibration to stimulate muscle tissues, or electronic pulses to create micro current through the body, so that a massaging effect is attained. However, the action that can be produced from these massaging apparatuses is often restricted to one orientation, so the massaging effects are quite limited.

In these aspects, the sound-controlled massaging apparatus according to the present invention substantially departs from the conventional concepts and designs of the prior art.

### SUMMARY OF THE INVENTION

The primary objective of the present invention is to provide a sound-controlled massaging apparatus that is capable of monitoring massaging with variable intensity and frequency cycle controls, corresponding to audible music at an output thereof.

The secondary objective of the invention is to provide a massaging apparatus capable of delivering multiple massage functions using one machine, such as rolling, drumming, thumbing and vibrating through different operation modes.

To attain the above-mentioned objectives, the sound-controlled massaging apparatus comprises a power circuit, an audio signal processing circuit, a main control unit, a manual control unit, a massage mechanism, wherein the power circuit is connected to the power input of the main control unit; the audio signal processing circuit is connected to the main control unit; the manual control unit is connected to the main control unit; and the massage mechanism is connected to the output of the main control unit.

The present invention is characterized in that the input of the audio signal processing circuit is releasably connected to the sound generation source for continuously receiving audio signals, and the output is releasably connected to a speaker.

The present invention is also characterized in that the main control unit includes a microcontroller chip U2 and a driving circuit; and the manual control unit includes a microcontroller U1, a control panel, and a liquid crystal display (LCD); where the control panel is built in with an input key control circuit, and a switch.

Still another characteristic of the present invention is that the power circuit is formed to provide multiple output voltages to supply different internal components of the massaging apparatus.

Still another characteristic of the present invention is that the audio signal processing circuit is to receive audio signals from the sound generation source, reshape and amplify the signals, before passing them to the main control unit.

Still another characteristic of the present invention is that the audio signal processing circuit is to receive audio signals from the sound generation source through audio cable connection, and then to transmit the filtered signals to the main control unit.

Still another characteristic of the present invention is that audio signals are not only used to drive the motor array, but also adapted for the LCD display to show working information of the operation to the user, including information such as the intensity and frequency of massaging cycle.

Still another characteristic of the present invention is that the microcontroller U2 is to receive audio signals from the sound generation source, and then the driving circuit is to use them to generate drive pulse signals for driving the motors of respective vibrators and massage head, subjecting the body muscles to physical stimulus.

Still another characteristic of the present invention is that the input key control circuit, including multiple input keys, is used to manually control the operation of the massage mechanism, such as setting the operation time, intensity and frequency, and selecting the music and massage action.

Still another characteristic of the present invention is that when one of the input keys is depressed, a user instruction is generated by the input key control circuit, which is then translated to corresponding control signals to be transmitted to the main control unit.

Still another characteristic of the present invention is that when control signals are received the microcontroller U2 issues own instructions to control the activities of the massage mechanism accordingly.

Still another characteristic of the present invention is that the driving circuit is to receive control signals from the microcontroller U2, increase output power, and produce drive pulse signals to control the operation of the motor array accordingly.

Still another characteristic of the present invention is that when the motor array is in operation, the LCD display of the manual control unit is also enabled to display working information of the operation simultaneously.

Still another characteristic of the present invention is that the LCD display is to display working information of the operation, indicative of the intensity and frequency of massaging cycle.

Still another characteristic of the present invention is that the microcontroller U2 is a programmable processor having the A/D conversion function.

Still another characteristic of the present invention is that the LCD display including a display circuitry is controlled by the microcontroller U1, such that working information of the operation can be displayed corresponding to the audible music at an output thereof.

Still another characteristic of the present invention is that the audio signal processing circuit includes a pair of signal amplifiers, an integrating regulator, and a switching circuit.

Still another characteristic of the present invention is that the power circuit is formed by cascaded transformers, which deliver multiple output voltages to various internal components of the massaging apparatus.

Still another characteristic of the present invention is that the massage mechanism includes a massage head that is capable of performing rolling, drumming, thumbing actions, and multiple vibrators for producing vibrations at different locations, together providing physical stimulus to the body tissues when placed over the body or parts of the body.

Still another characteristic of the present invention is that each vibrator includes a sleeve movably mounted onto a base block, a motor disposed inside the base block, and eccentric wheel that is fixed on the shaft of the motor.

Still another characteristic of the present invention is that the manual control unit is used to control the operation of the massage mechanism in the manual mode, including an input key control circuit and a LCD display, a control panel having multiple input keys on the front surface and a switch.

Still yet another characteristic of the present invention is that the main control unit is to receive, analyze, process control signals derived from a user instruction, and then issues own instruction to the driving circuit for controlling the motor operations.

The present invention is advantageous over the prior arts in several ways: (1) Synchronous operation: audio signals input through the audio signal processing circuit are used to control the operation of corresponding motors of the massage mechanism, and also transmitted to the output speaker at the same time, thus the operation rhythm corresponds to the music being played. (2) Ease of use: input keys are used in manual mode, so when the user instructions are input through the input key control circuit to the main control unit, the driving circuit can control the operation of the vibrators and massage head corresponding to the user instructions. (3) Visual interface: the device is equipped with LCD display for displaying working information and current mode of operation through the LCD display, and the intensity and frequency of massaging action are represented by moving bars. (4) Intelligent apparatus: the massaging operation can incorporate thumbing, rolling, drumming, and vibrating actions to be applied on parts of the body such as neck, shoulder, back, lumbar, neck, thigh, and feet.

These along with other features of novelty which characterize the invention, are pointed out with particularity in the claims annexed to and forming a part of this disclosure. For a better understanding of the invention, the operating advantages and the specific objectives attained by its uses, references should be made to the accompanying drawings and descriptive matter illustrated in preferred embodiments of the invention.

### BRIEF DESCRIPTION OF THE DRAWINGS

FIG. 1 is a diagram of the primary architecture of the present invention;

FIG. 2 is a functional block diagram of the massaging apparatus;

FIG. 3 is a schematic of the power circuit in accordance with the invention;

FIG. 4 is a detailed circuit diagram showing the audio signal processing circuit and the manual control unit in relation to the microcontroller U2 of the main control unit;

FIG. 5 is a detailed block diagram of all system components in accordance with the invention;

FIG. 6 is a schematic of the microcontroller U1 and control circuitry in the manual control unit; and

FIG. 7 is a schematic of the microcontroller U2 and control circuitry in the main control unit.

### DETAILED DESCRIPTION OF THE PREFERRED EMBODIMENT

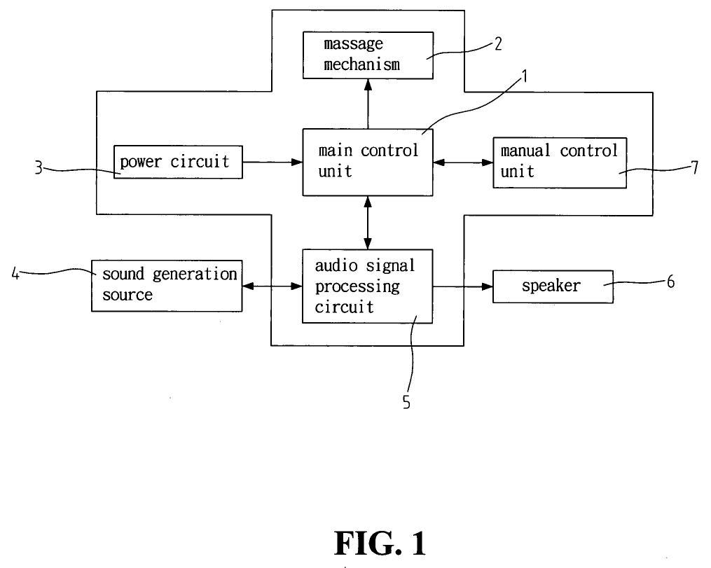

Referring to FIG. 1, a sound-controlled massaging apparatus in accordance with the present invention comprises a power circuit 3, an audio signal processing circuit 5, a main control unit 1, a sound generation source 4, a manual control unit 7, a speaker 6, and a massage mechanism 2.

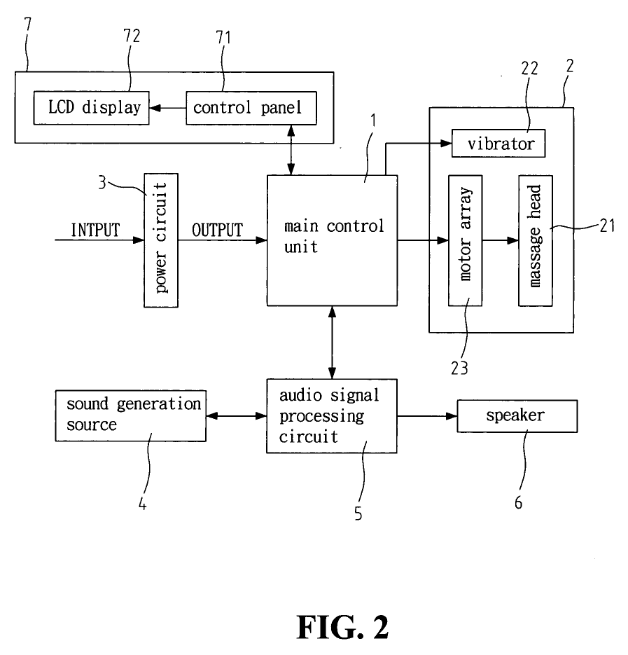

Referring to FIGS. 2, 4, and 5, the main control unit 1 includes a microcontroller U2 and a driving circuit 12; the manual control unit 7 includes a microcontroller U1, a control panel 71, and a liquid crystal display (LCD) 72.

The massage mechanism 2 includes a massage head 21 and multiple vibrators 22, where each vibrator 22 is constructed with a sleeve, a motor, and an eccentric wheel.

The control panel 71 is built in with an input key control circuit, and coupled with a switch.

The massaging apparatus is such that the output of the power circuit 3 is connected to the power input of the main control unit 1. The audio signal processing circuit 5 is connected to the main control unit 1 bi-directionally. The manual control unit 7 is connected to the main control unit 1 bi-directionally. The output of the main control unit 1 is connected to the input of the massage mechanism 2.

Audio signals derived from the sound generation source 4 are input to the audio signal processing circuit 5, and then through a pair of signal amplifiers 51 on the output of the right/left channels and an integrating regulator 52 the signals are reshaped before passing on to the main control unit 1.

The audio signal processing circuit 5 not only passes audio signals to the main control unit 1, but also transmits the signals to the speaker 6 for audio output.

The microcontroller U1 is used to monitor the input key control circuit. When the user depresses one of the input keys on the control panel 71, a user instruction is input to the microcontroller U1, which is then translated to control signals corresponding to the user instruction, and passed on to the main control unit 1.

The main control unit 1 that receives control signals from the microcontroller U1 of the manual control unit 7 is to issue own instruction to the message mechanism 2 for coordinating the activities of the massage head 21 and vibrators 22.

The main control unit 1 also issues an instruction to the audio signal processing circuit 5 to output audio signals through the speaker 6, so that the music that is used to drive the motor array 23 is also played at an output with the same rhythms.

The massaging apparatus can be operated interactively. When the user inputs an instruction through one of the input keys, the user can read the instruction information from the LCD display. Working information of the operation is also simultaneously displayed through the LCD display 72, indicating the massaging technique, intensity, and frequency of massaging cycle, which are represented by moving bar indicators.

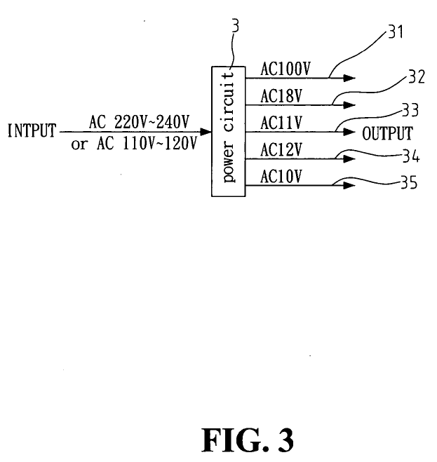

Referring to FIG. 3, the power circuit 3 is formed by multiple cascaded transfomers providing necessary power for operating the internal components. The power circuit may be adapted for AC 220-240V, or 100-120V to meet the power grid requirements for different countries. The microcontroller U2 has a 50/60 Hz frequency detection circuit that can detect whether the input voltage is 110V or 220V. The AC 100V (31) output of the power circuit, after rectification, is to be used for driving the motor array 23 and the massage head 21; the output AC 18V (32), through rectification, for fulfilling the compression control component; the output AC 11V (33), through rectification and power regulation, for all other components; and the output AC 10V (35), through rectification, power regulation and filtering, for the sound generation source 4 and related circuitry.

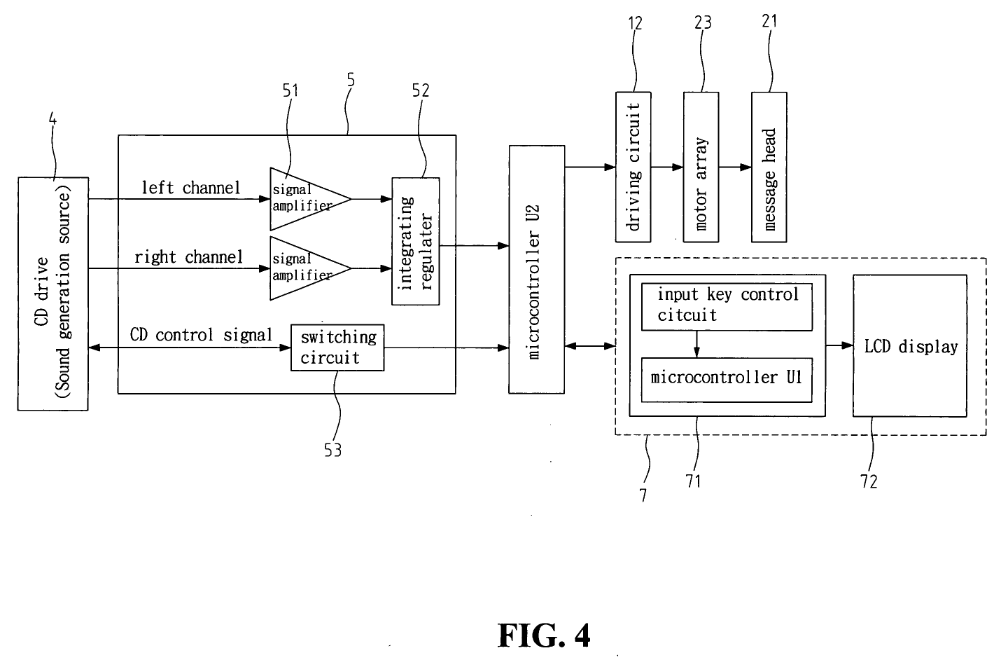

Referring to FIG. 4, the sound generation source 4 is a CD drive that generates audio signals through right and left channels when a selected CD is placed in the drive. The sound generation source 4 is controlled by the main control unit 1. When the audio signal processing circuit 5 receives the enable signal from the sound generation source 4, the signal is transmitted to the main control unit 1, which then issues control signals to the switching circuit 53 to activate and control the operation of sound generation source 4. Thereafter, audio signals are continuously fed from the sound generation source 4 to the audio signal processing circuit 5.

Through a pair of signal amplifiers 51 and an integrating regulator 52, the input signals are reconstructed and then passed to the microcontroller U2 having A/D function, to allow analog signals to be converted to corresponding digital signals. The digital signals are then transmitted to the driving circuit 12, and, after signal amplification, are used to control the speed adjustable motors 24 of the massage head 21 to perform various massage actions.

The sound-controlled massaging apparatus is designed to operate in three different modes: auto, programmed, and manual.

When operating in the auto mode, audio signals from the sound generation source 4 are continuously fed to the audio signal processing circuit 5, after signal amplification, the audio signals are transmitted to the main control unit 1, which then convert the analog signals to digital signals for driving the motor array 24 through the driving circuit 12, such that the action of the massage head 21 is in sync with the musical rhythms. The driving circuit 12 also drives the vibrators 22 into vibration according to the musical rhythm.

At the same time, a display instruction is sent out by the main control unit 1 to the manual control unit 7 to enable the LCD display 72 to show the operation mode, intensity and frequency of massaging cycle.

Also, at the same time, the main control unit 1 is to issue an instruction to the audio signal processing circuit 5 to cause the audio signals to be output to the speaker 6, so that the user is able to get a bodily massage while listening to music at the same time.

The manual control unit 7 is provided with a keypad on the control panel to allow the user to control the massage operation through input keys.

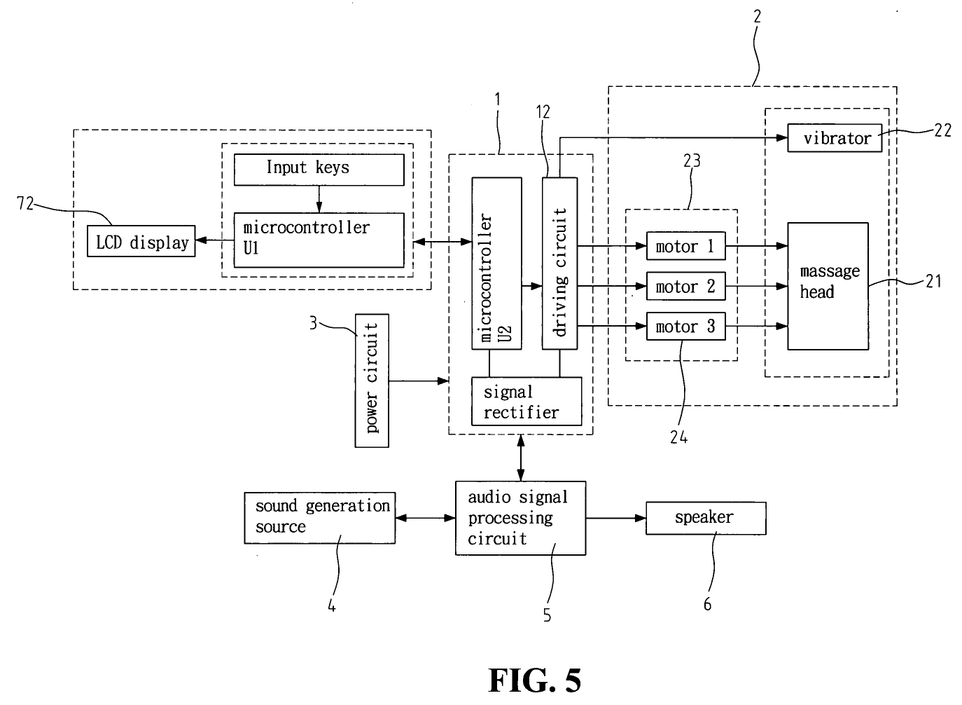

Referring to FIG. 5-7, in the manual mode, the operation is based on direct instructions input by the user. When one of the input keys is depressed, a corresponding user input signal is generated and temporarily recorded in a data register. The signal is then received by the microcontroller U1 and translated to corresponding control signals to be passed to the microcontroller U2 of the main control unit 1. The microcontroller U2 then generates own instructions to the driving circuit 12 to coordinate the functions of the motor array 23. At the same time, the main control unit 1 also sends signals to the LCD display for showing the instruction information to the user.

As the microcontroller U2 is a programmable processor, in the programmed mode, the operation can be executed according to pre-recorded program steps, such that the activities of the vibrators 22 and massage head 21 can be coordinated.

The microcontroller U2 of the main control unit 1 is connected by three signal sensors for separating the audio spectrum of an audio signal into three different parts, which will be treated independently, such that through the input signal processing the operation of the massage mechanism 2 can be optimized.

A stroke switch or relay is also connected to the microcontroller U2 to provide an electrical indication of machine activity to a stroke counter for the purpose of adjusting the maximum massaging cycle frequency of the massage mechanism 2.

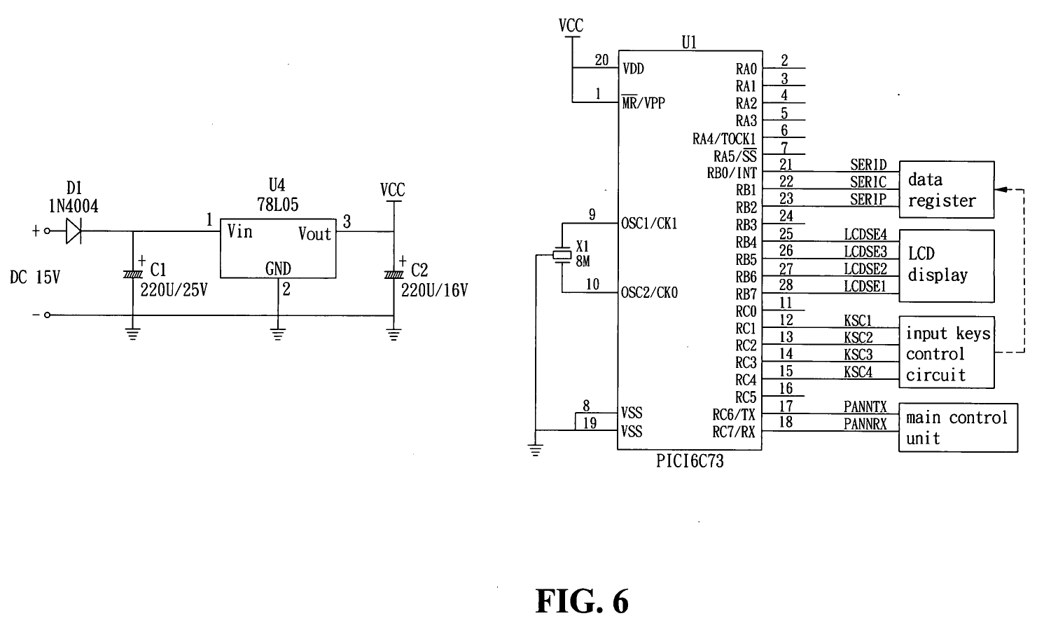

Referring to FIG. 6, Vcc of the manual control unit 7 is derived from a 15V DC input, through filter C1, C2, and a 3-terminal positive voltage regulator U4 (78L05), a constant voltage is supplied to the microcontroller U1 (PIC16C73) and its control circuitry, including the input key control circuit, display circuit, and data registers.

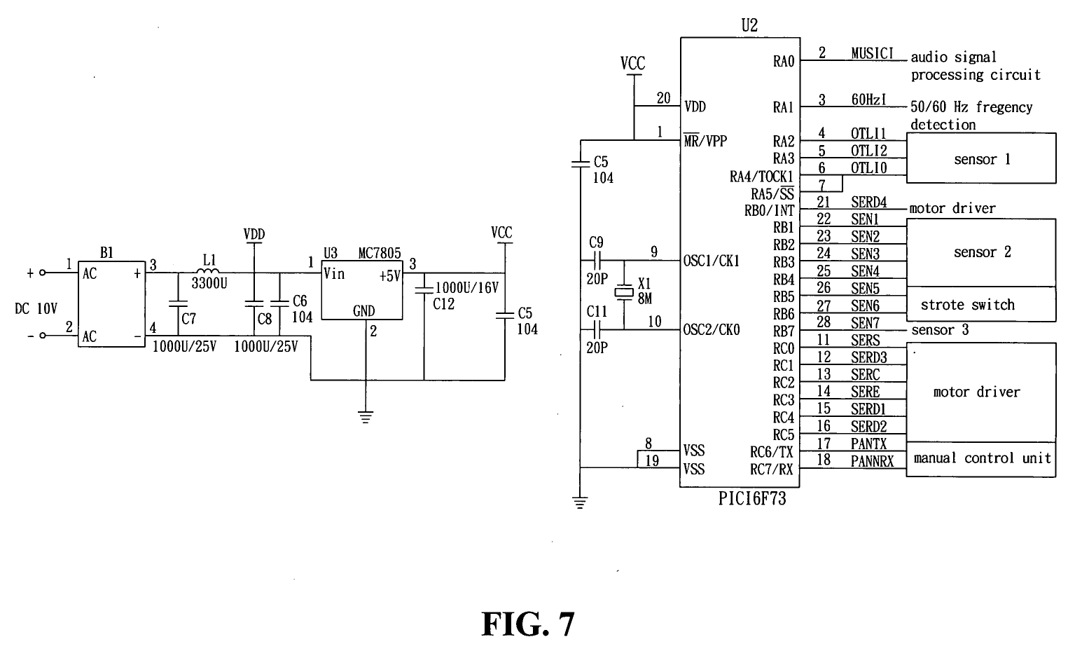

Referring to FIG. 7, Vcc of the microcontroller U2 is derived from 10V DC input, through a bridge rectifier B1, and LC filter C6, C7, C8 and L1, Vdd is supplied to the driving circuit 12, and then further through a 3-terminal positive voltage regulator U3 (MC7805), a constant voltage DC is supplied to the microcontroller U2 (PIC16F73).

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A sound-controlled massaging apparatus, comprising:
a power circuit, an audio signal processing circuit, a main control unit, a manual control unit, and a massage mechanism, where the main control unit includes a microcontroller U2 and a driving circuit; and the manual control unit includes a microcontroller U1, an input key control circuit, a LCD display, and a switch; and the LCD display includes a display circuit;
wherein the power circuit is connected to the power input of the main control unit; the audio signal processing circuit is connected to the main control unit bi-directionally; the manual control unit is connected to the main control unit bi-directionally; and the massage mechanism is connected to the output of the main control unit;
the sound-controlled massaging apparatus characterized in that
when the microcontroller U2 receives audio signals from the audio signal processing circuit, the analog signals are converted to digital signals, and then transmitted to the driving circuit to coordinate the functions of the massage mechanism;
when the manual control unit receives a user input signal, the input signal is transmitted to the microcontroller U1 which is then translated to control signals according to the user instruction, and then passed on to the microcontroller U2 of the main control unit for controlling motor actions; and
when the microcontroller U1 receives display instruction from the main control unit, the LCD display is enabled to display the current massage information to the user, including the current operation mode, intensity and frequency of massaging cycle.

2. The sound-controlled massaging apparatus as claimed in claim 1, wherein the microcontrollers U1 and U2 are programmable processors having A/D signal conversion function.

3. The sound-controlled massaging apparatus as claimed in claim 1, wherein the microcontroller U2 is a PIC16F73 chip.

4. The sound-controlled massaging apparatus as claimed in claim 2, wherein the microcontroller U2 is a PIC16F73 chip.

5. The sound-controlled massaging apparatus as claimed in claim 1, wherein the microcontroller U1 is a PIC16F73 chip.

6. The sound-controlled massaging apparatus as claimed in claim 2, wherein the microcontroller U1 is a PIC16F73 chip.

7. The sound-controlled massaging apparatus as claimed in claim 5 wherein the main control unit further includes a signal rectifier.

8. The sound-controlled massaging apparatus as claimed in claim 6 wherein the main control unit further includes a signal rectifier.

9. The sound-controlled massaging apparatus as claimed in claim 7, wherein the microcontroller U2 is designed with a frequency detection circuit for determining whether the frequency of the input signal is 50/60 Hz.

10. The sound-controlled massaging apparatus as claimed in claim 8, wherein the microcontroller U2 is designed with a frequency detection circuit for determining whether the frequency of the input signal is 50/60 Hz.

11. The sound-controlled massaging apparatus as claimed in claim 3, wherein the audio signal processing circuit is formed by a pair of signal amplifiers, an integrating regulator and a switching circuit.

12. The sound-controlled massaging apparatus as claimed in claim 4, wherein the audio signal processing circuit is formed by a pair of signal amplifiers, an integrating regulator and a switching circuit.

13. The sound-controlled massaging apparatus as claimed in claim 11, wherein the input of the audio signal processing circuit is releasably connected to a sound generation source, and the output is releasably connected to a speaker.

14. The sound-controlled massaging apparatus as claimed in claim 12, wherein the input of the audio signal processing circuit is releasably connected to a sound generation source, and the output is releasably connected to a speaker.

15. The sound-controlled massaging apparatus as claimed in claim 13, wherein the power circuit is formed by multiple cascaded transformers to generate power supply for all internal components.

16. The sound-controlled massaging apparatus as claimed in claim 14, wherein the power circuit is formed by multiple cascaded transformers to generate power supply for all internal components.

17. The sound-controlled massaging apparatus as claimed in claim 15, wherein the massage mechanism includes a massage head that is able to produce rolling, drumming and thumbing actions, and multiple vibrators that respectively produce vibrations, where each vibrator is constructed with a sleeve movably mounted on a base block, a motor disposed inside the base block, and an eccentric wheel fixed on the shaft of the motor.

18. The sound-controlled massaging apparatus as claimed in claim 16, wherein the massage mechanism includes a massage head that is able to produce rolling, drumming and thumbing actions, and multiple vibrators that respectively produce vibrations, where each vibrator is constructed with a sleeve movably mounted on a base block, a motor disposed inside the base block, and an eccentric wheel fixed on the shaft of the motor.
